(19) United States
(12) Patent Application Publication
(10) Pub. No.: US 2006/0065481 A1
(43) Pub. Date: Mar. 30, 2006

(54) Perforated hard trim for sound absorption

(75) Inventor: Terence Connelly, Plymouth, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/950,268

(22) Filed: Sep. 24, 2004

(51) Int. Cl. E04B 1/82; E04B 2/02; B64F 1/26; G10K 11/00; E04H 17/00

(52) U.S. Cl. 181/290; 181/210

(57) ABSTRACT

A perforated hard trim construction for incorporation into a an automobile interior with sound absorbing properties is provided. In one variation, the perforated hard trim construction includes a non-perforated metal component and a perforated hard trim component having a plurality of openings and connected to the non-perforated metal component. The plurality of openings have a sufficient total area such that the random incidence absorption coefficient is greater than about 0.1 for one-third octave center frequencies from about 1000 to about 10000 Hz. In an important variation, an porous sound absorbing material is interposed between the non-perforated hard trim component and the perforated hard trim component.

### BACKGROUND OF THE INVENTION

1. Field of the Invention

The present invention relates to automobile interior trim sound absorbing components.

2. Background Art

There is an increasing demand for the reduction of sound levels to improve perception in the passenger compartments of automobiles. Development of methods and systems that accomplish such reductions require an understanding of the potential internal and external noise sources in an automobile as well as the effect of various automobile components in masking or attenuating such noise. Moreover, reduction of noise in the 1 KHZ to 5 KHz frequency range is particularly desirable due to the increase sensitivity of vehicle passengers in that range for speech intelligibility and speech clarity.

The attenuation of sound waves present in automobile passenger compartments is accomplished by a number of components. For example, headliners have been designed to include sound absorbing or attenuating material. However, success using sound attenuating headliners has been limited by material properties and design restraints. Moreover, incorporation of complicated sound absorbing systems and components into an automobile are undesirable because of the additional costs of such systems and the added burden of incorporation in an aesthetically pleasing manner.

Various strategies for reducing passenger compartment noise using perforated structures. For example, EP1202874B1 discloses a perforated structure for a headliner. Similarly, M. van Ruiten et al disclose a perforated panels for vehicle interiors that operate at least to some degree as Helmholtz resonators. (M. van Ruiten et al, Improved Acoustics Through Perforated Plastic Panels, 2003 SAE Noise & Vibration Conference Proceedings, May 5th-8th 2003, Traverse City, Mich.) Although these perforated structures work reasonably well, these prior are structures tend to utilize rather large perforations that may interfere with the aesthetics of the passenger compartment and degrade the integrity of structural components. Moreover, additional sound reduction is still desired.

Accordingly, their exists a need in the prior art for more economical and efficient systems for reducing noise in an automobile passenger compartment.

### SUMMARY OF THE INVENTION

The present invention overcomes one or more problems of the prior art by providing in one embodiment a perforated hard trim construction for incorporation into a an automobile interior with sound absorbing properties. The perforated hard trim construction includes a non-perforated metal component and a perforated hard trim component having a plurality of openings and connected to the non-perforated metal component. The plurality of openings have a sufficient total area such that the random incidence absorption coefficient is greater than about 0.1 for one-third octave center frequencies from about 1000 to about 10000 Hz. The perforated hard trim construction also include an external absorbing material covering the perforated hard trim component and a fabric layer covering the first absorbing layer.

In another embodiment of the invention, a perforated hard trim construction is provided. The perforated hard trim construction of this embodiment includes a non-perforated metal component and a perforated hard trim component. The perforated hard trim component has a plurality of openings and is connected to the non-perforated metal component. The construction of this embodiment is distinguished from the first embodiment in that it further includes an porous sound absorbing material interposed between the non-perforated hard trim component and the perforated hard trim component.

### BRIEF DESCRIPTION OF THE DRAWINGS

FIG. 1 is a schematic of a typical hard trim construction found in an automobile;

FIG. 2 is a schematic of the automobile interior sound absorbing component of the present invention;

FIG. 3 provides plots of the sound absorption of the perforated trim component of the present invention with and without an interposed absorbing foam as compared to a non-perforated trim component;

FIG. 4 provides plots of the sound absorption of the perforated trim component of the present invention without an interposed absorbing foam for various open area amounts with 0.25 mm radius holes;

FIG. 5 provides plots of the sound absorption of the perforated trim component of the present invention without an interposed absorbing foam for various open area amounts with 1 mm radius holes;

FIG. 6 provides plots of the sound absorption of the perforated trim component of the present invention without an interposed absorbing foam for various open area amounts with 2 mm radius holes;

FIG. 7 provides plots of the sound absorption of the perforated trim component of the present invention without an interposed absorbing foam for various open area amounts with 3 mm radius holes; and

FIG. 8 provides plots of the sound absorption of the perforated trim component of the present invention with an interposed absorbing foam for various open area amounts with 1 mm radius holes.

### DETAILED DESCRIPTION OF THE PREFERRED EMBODIMENT(S)

Reference will now be made in detail to the presently preferred compositions or embodiments and methods of the invention, which constitute the best modes of practicing the invention presently known to the inventors.

“Random-incidence sound absorption” as used herein is the difference of the Sabine absorption of a reverberation chamber with and without the sample under test present. The sound absorption coefficient of the sample is calculated by dividing the Sabine absorption of the sample by the surface area of the sample.

“Sabine absorption” as used herein refers to the sum of absorptions due to objects and surfaces in a room, and due to dissipation of energy in the medium within the room.

“Reverberation chamber” as used herein means a specially designed acoustic room to approximate a diffuse field by minimizing the sound absorption of all surfaces.

“Third-octave band” as used herein means a band of frequencies extending one-third of an octave from 0.891 f₀ to 1.122 f₀, where f₀ is the band-center frequency. The band-center frequency is also referred to herein as the one-third octave center frequency.

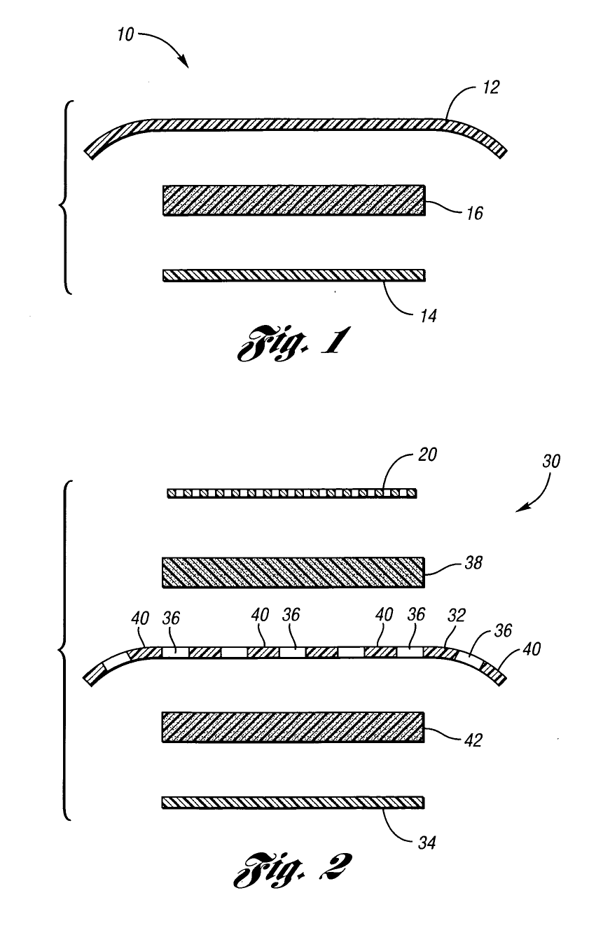

In an embodiment of the invention, a perforated hard trim construction for incorporation into a an automobile interior with sound absorbing properties. The perforated hard trim construction includes a non-perforated metal component and a perforated hard trim component having a plurality of openings and connected to the non-perforated sheet metal component. The present invention represents an improvement over the typical hard trim constructions currently used in many automobiles. With reference to FIG. 1, a schematic of such a hard trim construction is provided. Hard trim construction 10 includes hard trim component 12 which is connected to steel sheet 14. Such connection may be accomplished by methods known to those skilled in the art. Hard trim component 12 is typically about 3 mm thick and may be formed from a wide selection of material that include plastics, metals, etc. Porous absorber 16 is interposed between hard trim component 10 and steel sheet 14.

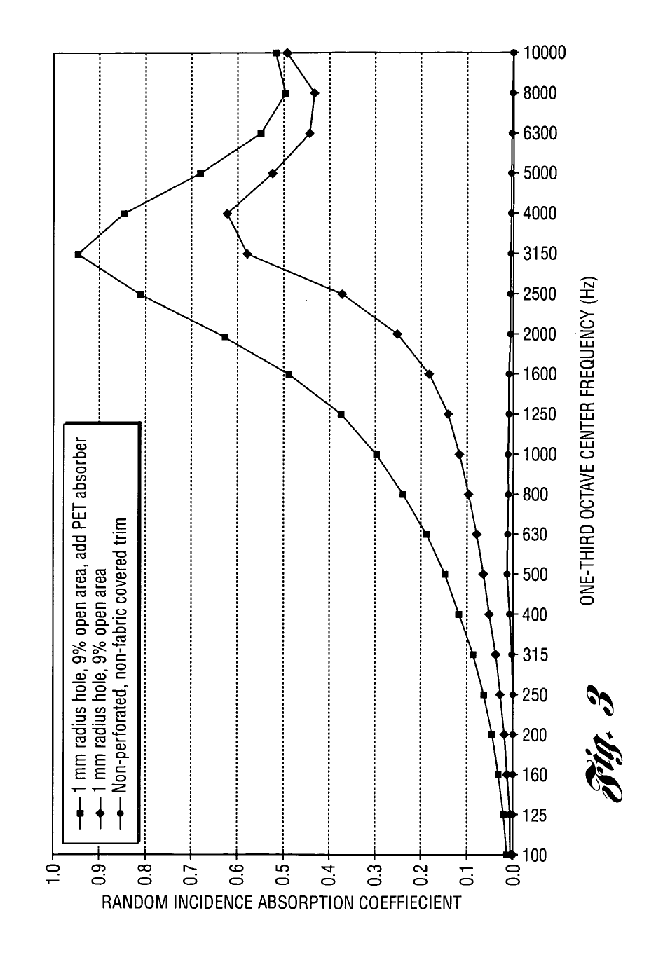

With reference to FIG. 2, a schematic of the perforated hard trim construction of the invention is provided. Perforated hard trim construction 30 include perforated hard trim component 32 which is connected to non-perforated metal component 34. Non-perforated trim metal component 34 is typically formed from a steel sheet. Moreover, non-perforated metal component 34 is advantageously a part of an automobile frame such as the A, B, C, D pillars.

Perforated hard trim component includes a plurality of openings 36 that have a sufficient total area to significantly absorb sound present in an automobile passenger compartment when the automobile is operated. Typically, the total area will be such that the random incidence absorption coefficient is greater than about 0.1 for one-third octave center frequencies from about 1000 to about 10000 Hz. In a variation of the present invention, the plurality of openings have a sufficient total area such that the random incidence absorption coefficient is greater than about 0.2 for one-third octave center frequencies from about 2000 to about 10000 Hz. The sound absorption properties of the perforated hard trim construction of the invention which depend on the spacing and area of the plurality of opening. Typically, the plurality of openings have a total surface area that is less than about 12% of the surface area of perforated hard trim component 32. Moreover, the average opening area of the plurality of openings 36 is less than about 30 mm². When a substantially circular hole is used as the opening, this area corresponds to a hole with a radium less than about 3.1 mm. In some variations of the invention, the plurality of openings have a total surface area from about 5% to about 10% of the surface area of the perforated hard trim component. In another variation of the invention, the average opening area in the plurality of openings is from about 0.10 to about 20 mm² (for substantially circular holes, this is a radius from about 0.18 mm to about 2.52 mm). In still other variations of the invention, the average opening area in the plurality of openings is from about 0.22 to about 10 mm² (for substantially circular holes, this is a radius from about 0.18 mm to about 1.78 mm). Although the openings of the plurality of openings may be of arbitrary shape, substantially circular holes are particularly useful because of their simplicity of manufacture (i.e., injection molding with pins, drilling). It is significant that the plurality openings use openings with a smaller area and have a lower total area than typically used in the prior art. The lower areas do not significantly interfere with the strength and structural integrity of parts into which the perforated hard trim construction of the invention is incorporated.

Still referring to FIG. 2, perforated hard trim construction 30 further includes exterior porous absorber 38 and fabric layer 20 which provide improved aesthetics by concealing openings 36. Moreover, exterior porous material 38 advantageously improves the sound absorbing properties of perforated hard trim construction 30. “Exterior” as used in this context means that exterior porous absorber 38 covers the outer surface 40 of hard trim component 32 and is not positioned between hard trim component 32 and non-perforated metal component 34. Although exterior porous absorber 38 made be constructed from any type of porous material, foamed material are particularly useful. The porosity of exterior porous absorber 38 is at least partially characterized by its density which is typically from about 10 kg/m³ to about 50 kg/m³. In other variations of the invention, exterior porous absorber 38 has a density from about 20 kg/m³ to about 30 kg/m³.

In a particularly useful variation of the invention, perforated hard trim construction 30 includes interior porous absorber 42 interposed between perforated hard trim component 32 and non-perforated metal component 34. The presence of interior porous absorber 42 significantly increases the sound absorbing properties of the invention. Although any porous material may be used for interior porous absorber 42, absorbers made from PET or cotton shoddy are particularly useful. In this variation, the plurality of openings have a sufficient total area such that the random incidence absorption coefficient is typically greater than about 0.2 for one-third octave center frequencies from about 1000 to about 10000 Hz. In yet another variation of the present invention in which interior porous absorber 42 is used, the plurality of openings have a sufficient total area such that the random incidence absorption coefficient is greater than about 0.2 for one-third octave center frequencies from about 2000 to about 10000 Hz.

The porosity of interior porous absorber 42 is at least partially characterized by its density which is typically from about 10 kg/m³ to about 50 kg/m³. In other variations of the invention, interior porous absorber 42 has a density from about 20 kg/m³ to about 30 kg/m³. In yet other variations of the invention, interior porous absorber 42 has a density of about 26.5 kg/m³.

Finally, although placement of the perforated hard trim construction of the invention at any location in an automobile passenger compartment. Placement at positions close to the height of passengers heads is desirable. Such positions include locations on the A, B, C, or D pillars above the midline of the care (above the bottom of the vehicle windows.) The following examples illustrate the various embodiments of the present invention. Those skilled in the art will recognize many variations that are within the spirit of the present invention and scope of the claims.

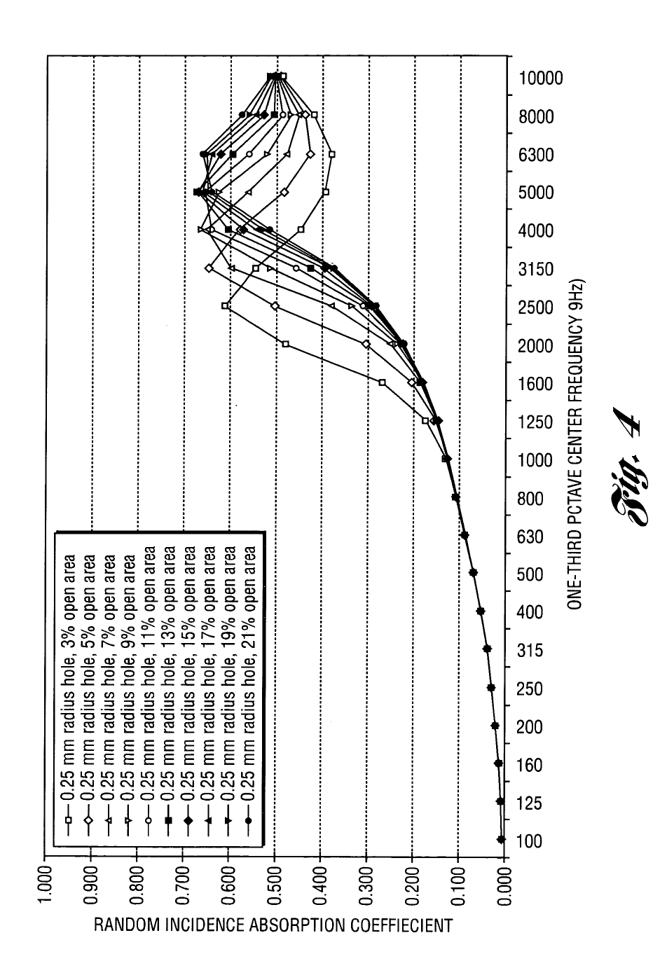

With reference to FIG. 3 plots of the sound absorption of the perforated trim component of the present invention with and without an interposed absorbing foam as compared to a non-perforated trim component are provided. The plots of FIG. 3 were generated by use of the MNS/Nova software which is commercially available from Sherbrooke University located in Quebec, Canada. MNS/Nova is a multipurpose acoustics prediction tool based on the transfer matrix method (“TMM”). This method is essentially based on the representation of plane wave propagation in different media in term of transfer matrices and this approach allows for the acoustic performance of multi-layered material made up from a combination of elastic, porous-elastic and fluid layers to be predicted. In a given layer, sound propagation is represented by a transfer matrix [T] such that V(M₁) [T] V(M₂), where M₁ and M₂ are two points set close to the forward and backward face of the layer, respectively, and where the components of the vector V(M) are the variables which describe the acoustic field in a point M of the medium. Using continuity equations at different interfaces, and the impedance equations in the source and receiving domains (assumed semi-infinite), a global system of equation is formed and solved for the reflection and transmission coefficients. Combination of different domains including porous-elastic, equivalent and classical fluids, elastic and viscoelastic solids, plates, shells, sandwich and composites, resistive screens, perforated plates, etc., can be combined and analyzed in NOVA.

FIG. 3 demonstrate that the inclusion of 1 mm radius holes in the hard trim component provides a significant increase in sound absorption. The random incidence absorption coefficient is observed to increase at about a one-third octave center frequency of about 250 Hz when compared to a non-perforated trim component. At a frequencies above about 1000 Hz, the random incidence absorption coefficient is observed to be greater than about 0.1. A maximum random incidence absorption coefficient is achieved in the range of about 2500 Hz to about 5000 Hz with a peak value of about 0.6 being achieved. The inclusion of a PET absorber between the perforated hard trim component and the non-perforated component is found to significantly increase the sound absorption. Values of the random incidence absorption coefficient over 0.1 are achieved at frequencies as low as about 400 Hz. Maximum sound absorption is observed in the 2000 Hz to 4000 Hz range with a value over 0.9 being achieved.

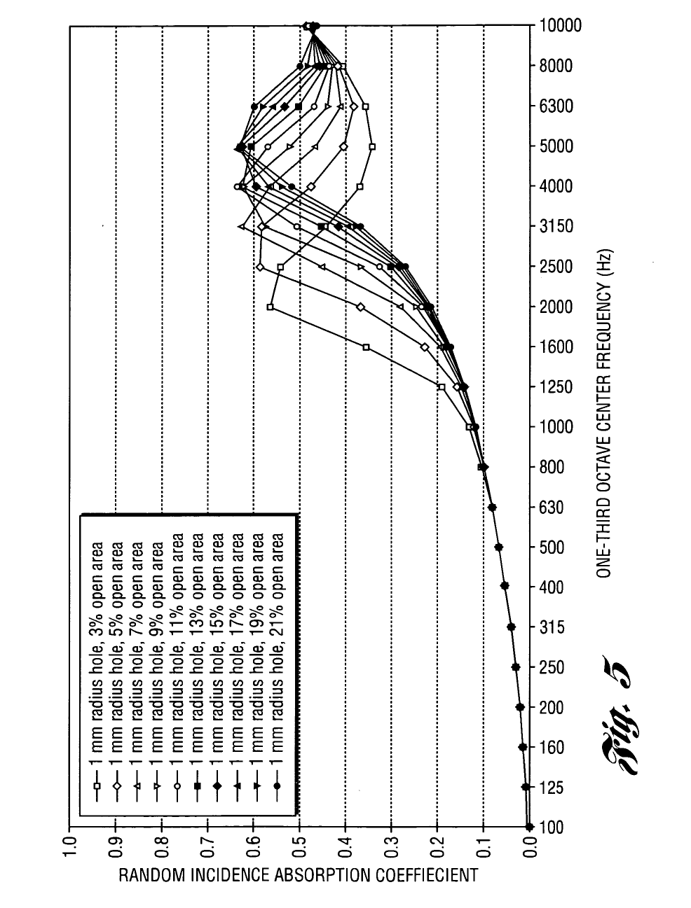

With reference to FIG. 4 a series of plots generated with the Nova software package of the sound absorption of the perforated trim component of the present invention without an interposed absorbing foam for various open area amounts with 0.25 mm radius holes. The plots demonstrate a tendency of shifting the maximum sound absorption to higher frequencies as the percent of the open area is increased. Maximal absorption in the 1000 Hz to 5000 Hz range is found for open areas of 5% to 9%.

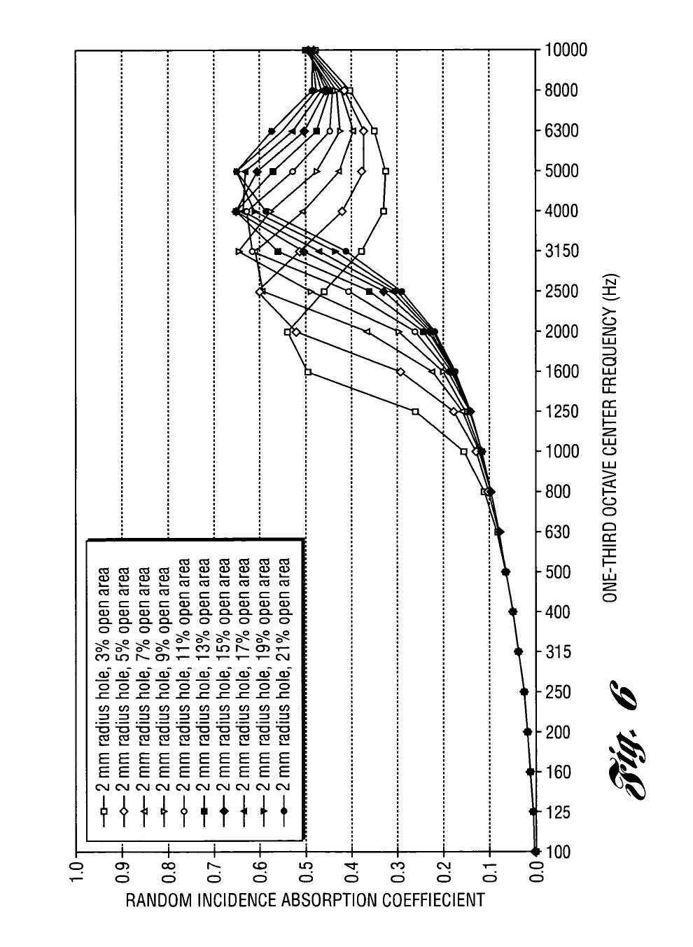

With reference to FIG. 5 a series of plots generated with the Nova software package of the sound absorption of the perforated trim component of the present invention without an interposed absorbing foam for various open area amounts with 1 mm radius holes are provided. The results for this series of plots is similar to FIG. 5 and again a tendency of shifting the maximum sound absorption to higher frequencies as the percent of the open area is increased is demonstrated. Maximal absorption in the 1000 Hz to 5000 Hz range is found for open areas of 3% to 11%. Moreover, optimal performance in the 1000 Hz to 5000 Hz range is observed for total open areas from about 5% to about 9%.

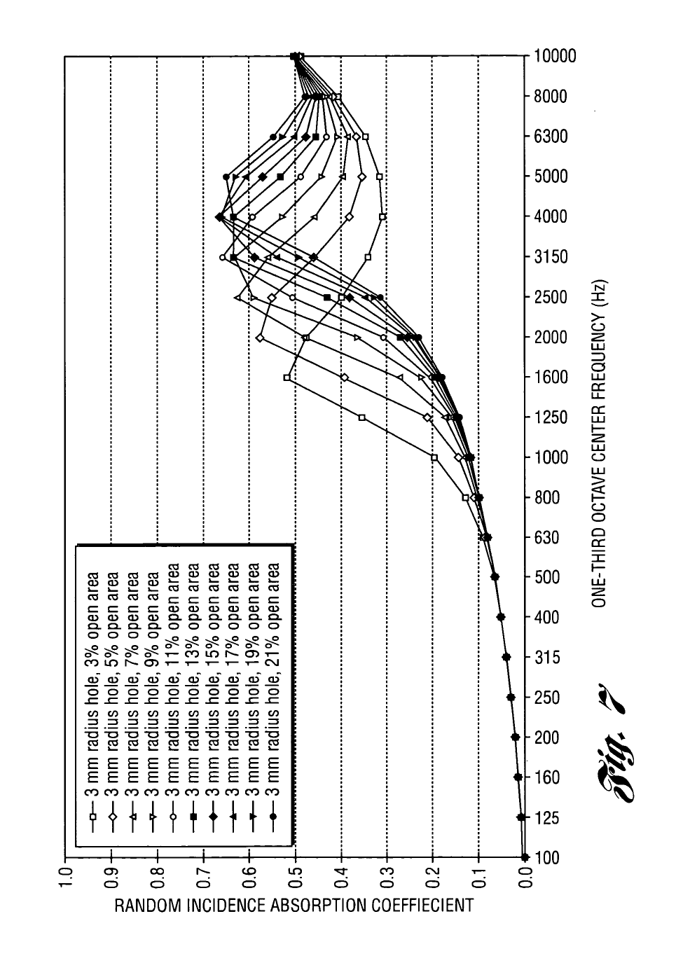

With reference to FIG. 6 a series of plots generated with the Nova software package of the sound absorption of the perforated trim component of the present invention without an interposed absorbing foam for various open area amounts with 2 mm radius holes are provided. The results for this series of plots is similar to FIG. 5 and again a tendency of shifting the maximum sound absorption to higher frequencies as the percent of the open area is increased is demonstrated. Again, maximal absorption in the 1000 Hz to 5000 Hz range is found for open areas of 5% to 9%.

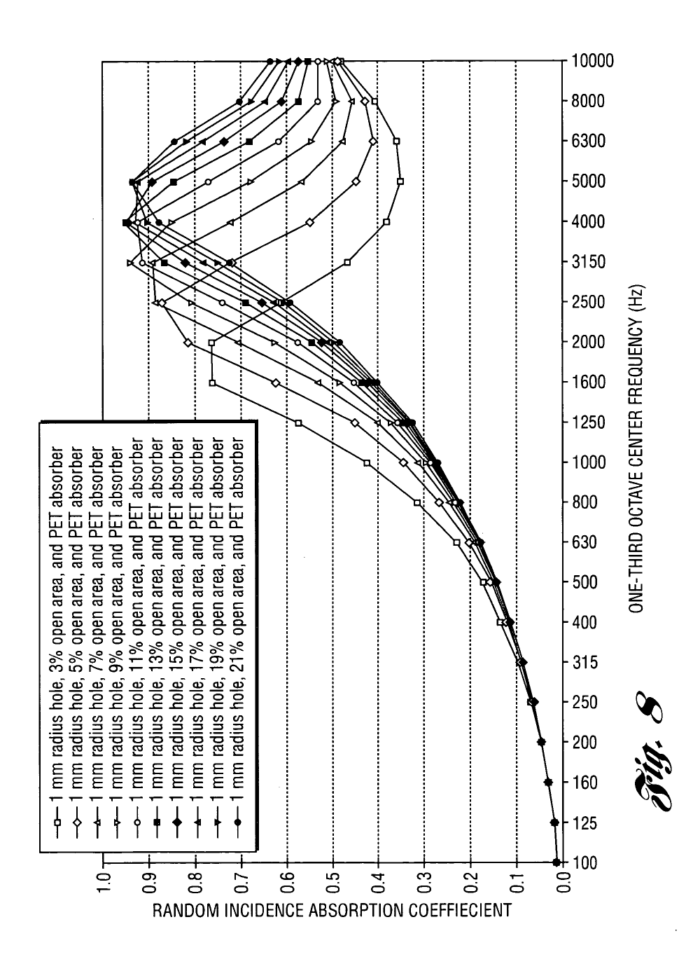

With reference to FIG. 7 a series of plots generated with the Nova software package of the sound absorption of the perforated trim component of the present invention without an interposed absorbing foam for various open area amounts with 3 mm radius holes are provided. The results for this series of plots is similar to FIG. 5 and again a tendency of shifting the maximum sound absorption to higher frequencies as the percent of the open area is increased is demonstrated. Again, maximal absorption in the 1000 Hz to 5000 Hz range is found for open areas of 5% to 9%.

With reference to FIG. 8 a series of plots generated with the Nova software package of the sound absorption of the perforated trim component of the present invention with an interposed absorbing foam for various open area amounts with 1 mm radius holes are provided. This series of plots demonstrated a similar frequency dependence as observed in FIGS. 4 and 5. However, the value of the random incidence absorption coefficient is observed to be high with incorporate of a PET absorber when compared to a perforated trim construction without such an absorber.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A perforated hard trim construction for absorbing sound in an automobile interior, the perforated hard trim construction comprising:
a non-perforated metal component;
a perforated hard trim component having a plurality of openings and connected to the non-perforated metal component, wherein the plurality of openings have a sufficient total area such that the random incidence absorption coefficient is greater than about 0.1 for one-third octave center frequencies from about 1000 to about 10000 Hz;
a exterior absorbing material disposed over the perforated hard trim component; and
a fabric layer covering the first absorbing layer.

2. The perforated hard trim construction of claim 1 wherein the plurality of openings have a total surface area less than about 12% of the surface area of the perforated hard trim component wherein a average opening area in the plurality of openings is less than about 30 mm².

3. The perforated hard trim construction of claim 1 wherein the plurality of openings have a total surface area from about 5% to about 10% of the surface area of the perforated hard trim component.

4. The perforated hard trim construction of claim 3 wherein the average opening area in the plurality of openings is from about 0.10 to about 20 mm².

5. The perforated hard trim construction of claim 3 wherein the average opening area in the plurality of openings is from about 0.15 to about 10 mm².

6. The perforated hard trim construction of claim 1 wherein the plurality of openings have a sufficient total area such that the random incidence absorption coefficient is greater than about 0.2 for one-third octave center frequencies from about 2000 to about 10000 Hz.

7. The perforated hard trim construction of claim 1 further comprising an interior porous material interposed between the non-perforated metal component and the perforated hard trim component.

8. The perforated hard trim construction of claim 7 wherein the porous material has a density from about 10 kg/m³ to about 50 kg/m³.

9. The perforated hard trim construction of claim 8 wherein the porous material has a density from about 20 kg/m³ to about 30 kg/m³.

10. The perforated hard trim construction of claim 1 wherein the plurality of openings are a plurality of substantially circular holes.

11. A automobile interior perforated hard trim construction comprising:
a non-perforated metal component;
a perforated hard trim component having a plurality of openings and connected to the non-perforated metal component, the plurality of openings having a total surface area less than about 12% of a surface area of the non-perforated metal component wherein the average area of an opening in the plurality of openings is less than about 30 mm²; and
a porous material interposed between the non-perforated metal component and the perforated hard trim component; wherein the interior perforated hard trim construction has a random incidence absorption coefficient is greater than about 0.2 for one-third octave center frequencies from about 1000 to about 10000 Hz.

12. The perforated hard trim construction of claim 11 wherein the plurality of openings have a total surface area from about 5% to about 10% of the surface area of the perforated hard trim component.

13. The perforated hard trim construction of claim 12 wherein the average opening area in the plurality of openings is from about 0.10 to about 20 mm².

14. The perforated hard trim construction of claim 12 wherein the average opening area in the plurality of openings is from about 0.15 to about 10 mm².

15. The perforated hard trim construction of claim 11 wherein the porous material has a density from about 10 kg/m³ to about 50 kg/m³.

16. The perforated hard trim construction of claim 1 wherein the plurality of openings are a plurality of substantially circular holes.

17. The perforated hard trim construction of claim 11 further comprising:
an exterior absorbing material disposed over the perforated hard trim component; and
a fabric layer covering the first absorbing layer.

18. A automobile interior perforated hard trim construction comprising:
a non-perforated metal component;
a perforated hard trim component having a plurality of openings and connected to the non-perforated metal component, the plurality of openings having a total surface area less than about 12% of a surface area of the non-perforated metal component wherein the average area of an opening in the plurality of openings is less than about 30 mm²;
an interior porous material interposed between the non-perforated metal component and the perforated hard trim component;
an exterior absorbing material disposed over the perforated hard trim component; and
a fabric layer covering the first absorbing layer, wherein the interior perforated hard trim construction has a random incidence absorption coefficient is greater than about 0.2 for one-third octave center frequencies from about 1000 to about 10000 Hz.

19. The perforated hard trim construction of claim 18 wherein the average opening area in the plurality of openings is from about 0.10 to about 20 mm².

20. The perforated hard trim construction of claim 19 wherein the average opening area in the plurality of openings is from about 0.15 to about 10 mm².
